(19) United States
(12) Patent Application Publication
(10) Pub. No.: US 2026/0298127 A1
(43) Pub. Date: Oct. 1, 2026

(54) FLUID DISTRIBUTOR VALVE WITH TEMPERATURE SENSOR

(71) Applicant: Stoneridge Control Devices, Inc., Novi, MI (US)

(72) Inventors: Benjamin Allen Harriger, Bellville, OH (US); Robert James Steinman, Lexington, OH (US)

(21) Appl. No.: 19/477,217

(22) PCT Filed: Dec. 14, 2023
(86) PCT No.: PCT/US2023/083993

§ 371 Date: Oct. 21, 2025

(51) Int. Cl. F01P 3/20; B60H 1/00; F01P 7/14; F01P 11/14; F16K 31/00; G01K 7/22; H02K 7/116; H02K 9/19; H02K 11/25

(52) U.S. Cl. CPC F01P 3/20; B60H 1/00485; F01P 7/14; F01P 11/14; F16K 31/002; H02K 7/116; H02K 9/19; H02K 11/25; F01P 2007/146; G01K 7/22; H02K 2211/03

(57) ABSTRACT

A coolant distributor valve for a vehicle cooling system includes a housing that includes a valve body portion and an electronics portion. A valve is arranged in the valve body portion. A printed circuit board (PCB) is arranged in the electronics portion. A temperature sensor is electrically connected to the PCB. The temperature sensor is configured to detect a coolant temperature within the valve body portion.

### TECHNICAL FIELD

This disclosure relates to a fluid distributor valve for use in vehicle cooling systems, for example.

### BACKGROUND

A typical modern vehicle includes various components and subsystems for which it is desirable to regulate the temperature (i.e., heating and/or cooling to a desired temperature). One or more cooling loops include one or more heat exchangers through which one or more fluids are circulated in a controlled manner to provide cooling fluid at a desired temperature to the components. As vehicles have become more complex, the complexity of the cooling system has increased as well.

A typical cooling system found in vehicles such as those having electrified and/or hybrid drivetrains tend to be highly distributed architectures with a complex maze of cooling loops, sub-loops, pumps, and heat exchanges. Coolant distributor valves, controllers and temperature sensors used to direct the coolant through these cooling systems are separated from one another and distributed throughout the vehicle. The resultant cooling system is complicated and expensive to implement and maintain, and the coolant temperature may not be as accurately regulated as desired.

### SUMMARY OF THE INVENTION

In one exemplary embodiment, a coolant distributor valve for a vehicle cooling system includes a housing that includes a valve body portion and an electronics portion. A valve is arranged in the valve body portion. A printed circuit board (PCB) is arranged in the electronics portion. A temperature sensor is electrically connected to the PCB. The temperature sensor is configured to detect a coolant temperature within the valve body portion.

In a further embodiment of any of the above, the valve body portion includes a coolant passage, and the housing includes a passageway that is adjacent to the coolant passage. The temperature sensor is arranged in the passageway.

In a further embodiment of any of the above, the passageway is arranged in the valve body portion.

In a further embodiment of any of the above, the passageway is arranged in the electronics portion.

In a further embodiment of any of the above, the passageway is fluidly separated from the coolant passage.

In a further embodiment of any of the above, the temperature sensor is a thermistor.

In a further embodiment of any of the above, the electronics portion includes an electrical connector that is electrically connected to the temperature sensor via the PCB.

In a further embodiment of any of the above, the coolant distributor valve includes a motor that is arranged in the electronics portion and electrically connected to the PCB, and a geartrain is coupled between the motor and the valve.

In a further embodiment of any of the above, the coolant distributor valve includes a bracket that is operatively mounted to the housing in one of multiple positions.

In a further embodiment of any of the above, the bracket is captured between the valve body portion and the electronics portion.

In a further embodiment of any of the above, the bracket includes at least one aperture, and the housing includes at least one boss that is disposed in the at least one aperture. The valve body portion and the electronics portion are secured at the at least one boss.

In a further embodiment of any of the above, the bracket includes an opening and the housing extends through the opening.

In a further embodiment of any of the above, multiple fasteners secure the valve body portion and the electronics portion to one another in one position of multiple discrete positions.

In a further embodiment of any of the above, a vehicle cooling system includes the coolant distributor valve and includes multiple cooling loops. The coolant distributor valve interconnects at least two of the multiple cooling loops, and the valve is configured to move between multiple positions to direct a desired cooling flow through the at least two of the multiple cooling loops based upon the detected coolant temperature.

In a further embodiment of any of the above, the cooling loops include at least two of a battery, a vehicle cabin, a charging electronics and a motor.

In another exemplary embodiment, a method of assembling a coolant distributor valve includes arranging temperature sensor in a housing that includes a valve body portion and an electronics portion. A printed circuit board (PCB) is placed in the electronics portion. A valve is arranged in the valve body portion that has a coolant passage. The temperature sensor is adjacent to but separated from the coolant passage.

In a further embodiment of any of the above, the housing includes a passageway, and the arranging step includes inserting the temperature sensor in the passageway.

In a further embodiment of any of the above, the temperature sensor is mounted to the PCB.

In a further embodiment of any of the above, the method includes a step of installing a bracket between the valve body portion and the electronics portion in one of multiple discrete assembly positions.

In a further embodiment of any of the above, the method includes a step of securing the valve body portion to the electronics portion in one of multiple discrete assembly positions.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a schematic of one example vehicle cooling system.

FIG. 2 is a perspective view of a disclosed coolant distributor valve.

FIGS. 3A-3C illustrates three example mounting bracket orientations.

FIGS. 4A-4D illustrates several example valve body orientations.

FIG. 5 depicts another example valve body portion.

FIG. 6 is a cross-section of the coolant distributor valve with a temperature sensor and taken along line 6-6 in FIG. 2.

FIG. 7 is a cross-section of the coolant distributor valve taken along line 7-7 in FIG. 2.

FIG. 8 is another example housing portion illustrating another temperature sensor arrangement.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

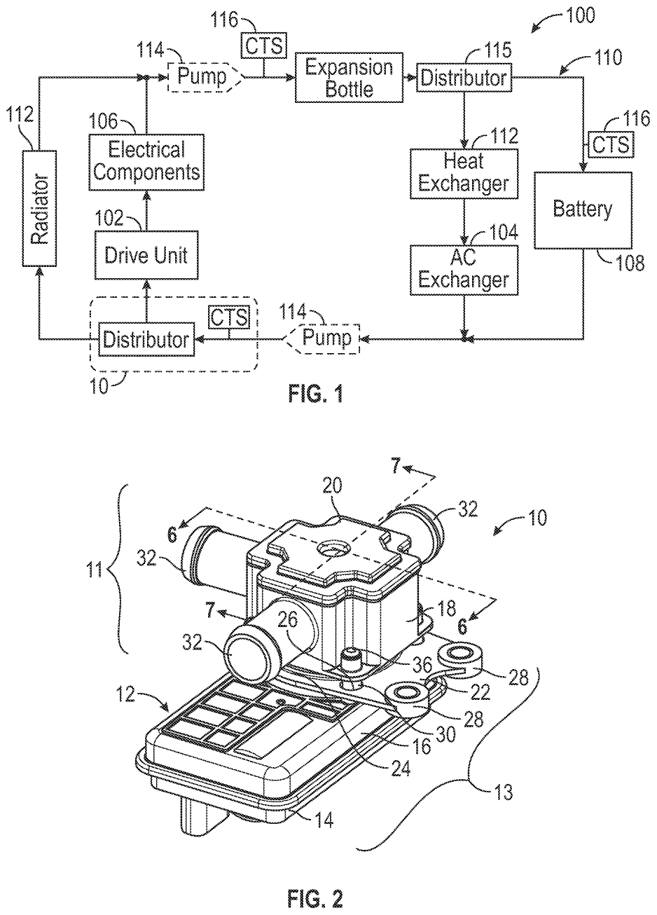

FIG. 1 depicts some aspects of a typical example vehicle cooling system 100, which is highly schematic and for illustrative purposes only. The system 100 tends to be relatively complex and include numerous loops, sub-loops, and branches for carrying a cooling fluid, such as a liquid coolant (e.g., water ethylene glycol). One type of vehicle includes one or more motors 102, an occupant cabin thermal conditioning system 104, a charging system 106, and a battery 108. One or more cooling loops 110 circulate the coolant through these components. Typically, multiple heat exchangers 112 are disbursed throughout the cooling loops 110 to provide a heat exchange from the coolant to another fluid such as air or another liquid coolant. One or more pumps 114 circulate the coolant through the cooling loops 110.

Multiple fluid distribution valves 115 connect multiple passages to selectively regulate the flow of coolant, and thus its temperature, through the cooling loops 110. The fluid distribution valves 115 are distributed throughout the cooling loop 110 as well as throughout the vehicle. Numerous temperature sensors 116 are also disbursed throughout the cooling system 100 to monitor the temperature at various locations in order to enable coordination of the various components to achieve desired temperatures throughout the system. A disclosed coolant distributor valve 10 integrates a temperature sensor 74 into the assembly in a reliable way that also provides more accurate temperature sensing, and therefore improved overall temperature regulation by the cooling system 100.

The coolant distributor valve 10 has a multi-piece housing 12 with multiple portions that are secured to one another by one or more attachment techniques (e.g., welding, fasteners, glue, sealant, etc.). In the example, there are two main housing portions: a valve body portion 11 and an electronics portion 13, which are fluidly separated from one another. In one example, the electronics portion 13 is provided by first and second housing portions 14, 16, and the valve body portion 11 is provided by third and fourth housing portions 18, 20.

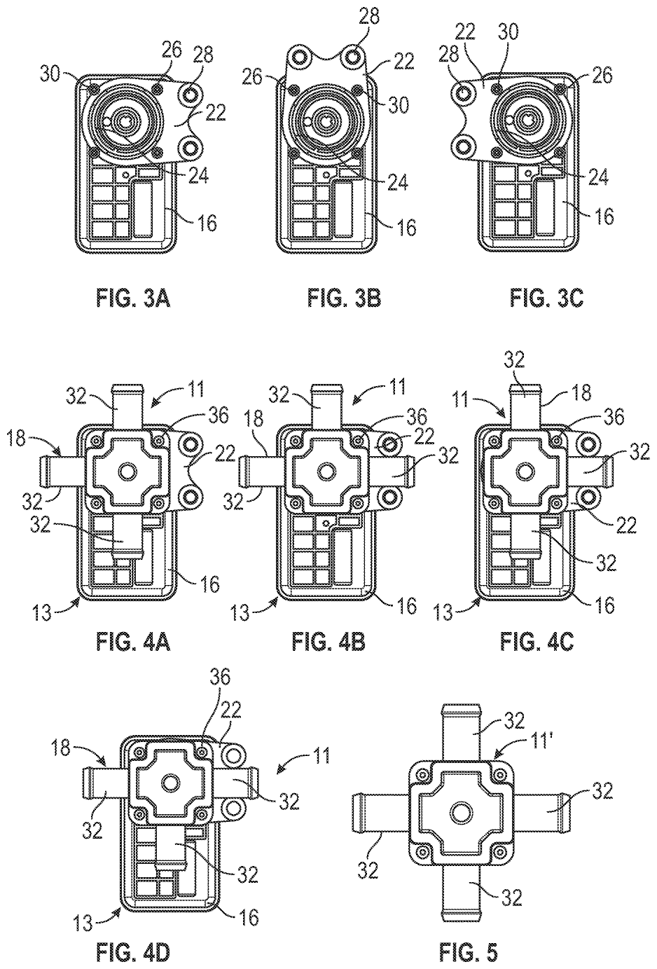

The coolant distributor valve 10 is designed to be configurable to provided flexibility in both packaging and versality in its use within a cooling system. One example of this flexibility is a reconfigurable bracket 22 operatively mounted to the housing 12, which can be oriented in several different discrete positions relative to the housing 12. The bracket 22 includes mounting features (e.g., pair of mounting ears 28) that are used to secure the coolant distributor valve 10 to the vehicle. With reference to FIGS. 2 and 3A-3C, the electronics portion 13 (e.g., second housing portion 16) includes bosses 30 that are arranged in a symmetrical pattern, for example. The bracket 22 includes apertures 26 arranged in a similar pattern and that are sized to receive the bosses 30. Bosses may instead or additionally be provided on the valve body portion 11, if desired. The bracket 22 is arranged between the valve body portion 11 and the electronics portion 13 and clocked to a desired orientation (see, e.g., FIGS. 3A-3C) based upon the packaging constraints within the vehicle. The valve body portion 11 and the electronics portion 13 interconnect and cooperate with one another through an opening 24 in the bracket 22.

The valve body portion 11 may also be clocked to a desired orientation relative to the electronics portion 13, as shown in FIGS. 4A-4D. Fasteners 36 secure the valve body portion 11 to the electronics portion 13 (e.g., second and third housing portions 16, 18) to one another, which captures the bracket 22. Different valve body portions 11′ (see, e.g., FIG. 5) may be secured to the electronics portion 13 based upon the number, size, orientation and other features desired. In this way, a manufacturer of the disclosed coolant distributor valve 10 may keep an inventory of common but different valve configurations that can be used with the same electronics portion 13, providing increased versatility to accommodate different cooling system needs.

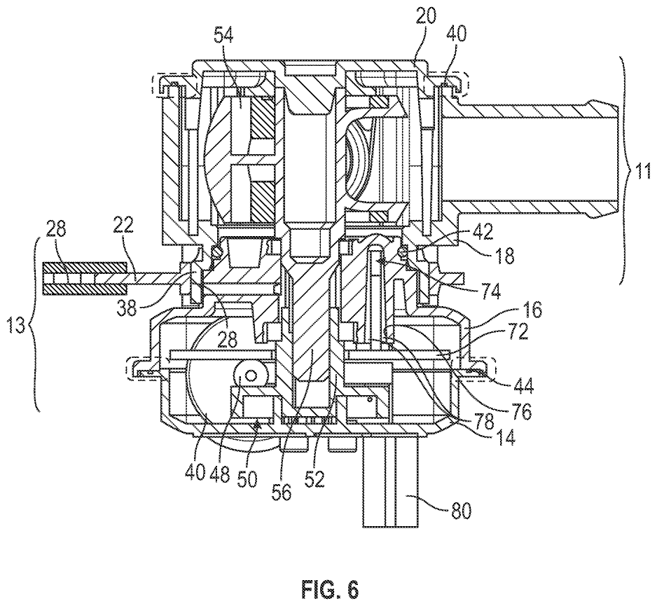

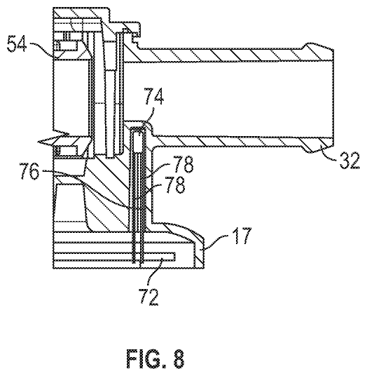

Referring to FIG. 6, a circumferential flange 38 of the valve body portion 11, which is mounted to the electronics portion 13, serves as a pilot for the opening 24 of the bracket 22. Although the valve body portion 11 is shown radially outward of the electronics portion 13 to locate the bracket 22, the structural relationship may be reversed so the valve body portion 11 is radially inward of the electronics portion 13 at this location. Furthermore, the second and third housing portions 16, 18 may be integrated with one another to provide an integrated, unitary structure forming housing portion 17 (FIG. 8) that provides a portion of the valve body portion 11 and the electronics portion 13. In this case, the bracket 22 may be mounted to the housing 12 in a different manner than illustrated.

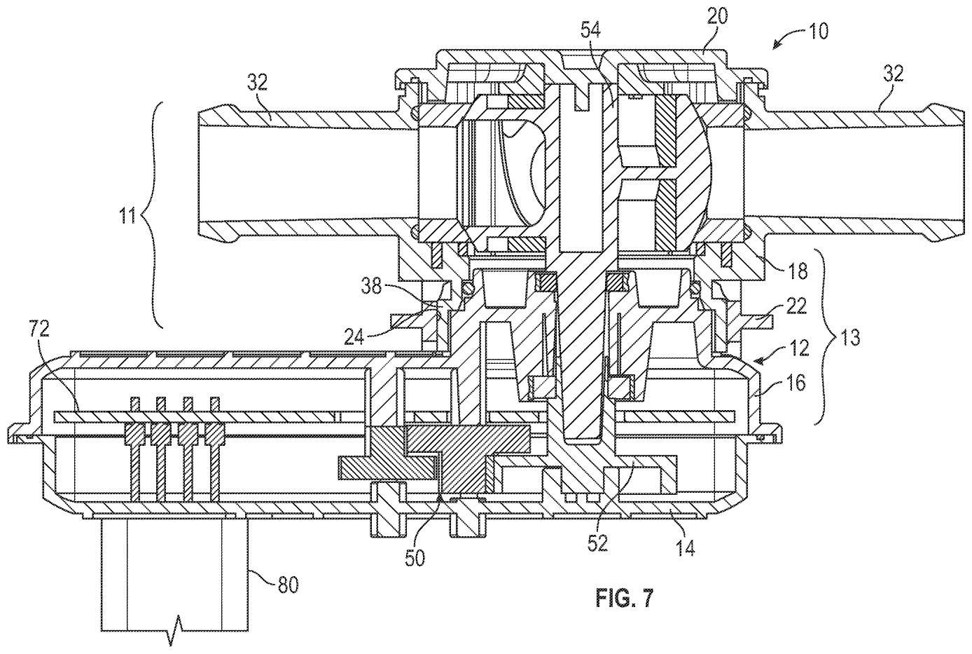

The various portions of the housing 12 are secured to and sealed with respect to one another using any number of techniques. In one example, the first and second housing portions 14, 16 are welded to one another at 40, as are the third and fourth housing portions 18, 20 (at 44). The second and third housing portions 16, 18 are sealed with an O-ring 42 and secured using the fasteners 36, in the example shown in FIGS. 2, 6 and 7.

A valve 54 is arranged in a coolant passage within the valve body portion 11 and is configured to rotate between multiple positions to fluidly connect and disconnect the fluid connectors 32 to one another and regulate the flow of coolant (e.g., water ethylene glycol) through the cooling system 100. The electronics portion 13 contains the sensitive electronic components like a motor 46 electrically connected to a printed circuit board (PCB) 72. The motor 46 includes a drive gear 48 that rotationally drives the valve 54 through a gear train 50 having a drive lug 52. In the example, the valve 54 is coupled to the drive lug 52 via a splined connection. First and second seals 58, 60 prevent coolant from leaking from the valve body portion 11 into the electronics portion 13, which would damage the electronics components within.

A temperature sensor 74, such as a thermistor, is electrically connected to the PCB 72 by electrical leads 78. An electrical connector 80 is provided by the electronics portion 13 and provides electrical communication with the motor 46, PCB 72 and the temperature sensor 74. The temperature sensor 74 is configured to detect a coolant temperature within the valve body portion 11 in close proximity to the coolant passage provided by the valve body portion 11. In the example shown in FIGS. 6 and 8, the electronics portion 13 (e.g., second housing portion 16) includes a passageway 76 adjacent to the cooling passage, with the temperature sensor 74 arranged in the passageway 76. In an example shown in FIG. 8, the passageway 76 is arranged in the valve body portion 17 that also provides a portion of the electronics portion. In either case, the passageway is fluidly separated from the coolant passage by a wall of the housing 12 to prevent coolant from migrating into the electronics portion 13.

The coolant distributor valve 10 diverts coolant from the input port to a selected output port provided by the fluid connections 32 and thereby connects at least two cooling loops (e.g., including at least two of a battery, a vehicle cabin, a charging electronics and a motor). Moving the valve 54 between multiple positions directs a desired cooling flow through the at least two of the multiple cooling loops based upon the detected coolant temperature. By combining the temperature sensor 74 into the coolant distributor valve 10 in close proximity to the coolant within, the temperature taken by the temperature sensor 74 is much more useful for evaluating which port to open or close or for providing information on other subsystems (i.e., zones in the cooling system 100) through which the coolant is flowing. For example, if the coolant distributor valve 10 and integrated temperature sensor 74 is connected to a battery 108, electrical charging voltage converter 106, electric motor 102, and/or a passenger cabin thermal conditioning system 104, it can collect temperature information from the coolant and help an internal (e.g., PCB 72) or external control unit make a much more accurate determination on what subsystem needs coolant or does not need coolant.

The controller (e.g., PCB 72) may be a hardware device for executing software, particularly software stored in memory. The controller (e.g., PCB 72) can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller (e.g., PCB 72) is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

In one example, the coolant distribution valve 10 is assembled by arranging the temperature sensor 74 in the housing 12. The housing 12 includes an electronics portion 13 (e.g., first and second housing portions 14, 16) and a valve body portion 11 (e.g., separate third and fourth housing portions 18, 20, or second and third housing portions 16, 18 integrated as unitary structure 17). A desired valve body portion (i.e., number, size, configuration, and orientation of fluid connectors) is selected for the cooling application. Depending upon the construction of the housing 12, the second and third housing portions 16, 18 may be secured to one another (e.g., fasteners, welding, glue, etc.). During this process, the bracket 22 is installed in in one of multiple discrete assembly positions (i.e., clocked to desired orientation of the possible orientations), and the valve body portion 11 is secured to the electronics portion 13 in one of multiple discrete assembly positions.

The PCB 72 is placed in the electronics portion. When the PCB 72 and the valve body portion 11 (e.g., portions 17 or 18) are brought together, the temperature sensor 74 is inserted into the passageway 76, which is isolated from the coolant passage. In the example, electrical leads 78 of the temperature sensor 74 are soldered to the PCB 72 during assembly, which is in turn electrically connected to the electrical connector 80. The valve 54 is arranged in the valve body portion 11. The temperature sensor 74 is adjacent to but separate from the coolant passage that is regulated by the valve 54.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A coolant distributor valve for a vehicle cooling system, comprising:
a housing including a valve body portion and an electronics portion;
a valve arranged in the valve body portion;
a printed circuit board (PCB) arranged in the electronics portion; and
a temperature sensor electrically connected to the PCB, wherein the temperature sensor configured to detect a coolant temperature within the valve body portion.

2. The coolant distributor valve of claim 1, wherein the valve body portion includes a coolant passage, and the housing includes a passageway adjacent to the coolant passage, the temperature sensor arranged in the passageway.

3. The coolant distributor valve of claim 2, wherein the passageway is arranged in the valve body portion.

4. The coolant distributor valve of claim 2, wherein the passageway is arranged in the electronics portion.

5. The coolant distributor valve of claim 2, wherein passageway is fluidly separated from the coolant passage.

6. The coolant distributor valve of claim 1, wherein the temperature sensor is a thermistor.

7. The coolant distributor valve of claim 1, wherein the electronics portion includes an electrical connector electrically connected to the temperature sensor via the PCB.

8. The coolant distributor valve of claim 1, comprising a motor arranged in the electronics portion and electrically connected to the PCB, and a geartrain coupled between the motor and the valve.

9. The coolant distributor valve of claim 1, comprising a bracket operatively mounted to the housing in one of multiple positions.

10. The coolant distributor valve of claim 9, wherein the bracket is captured between the valve body portion and the electronics portion.

11. The coolant distributor valve of claim 10, wherein the bracket includes at least one aperture, and the housing includes at least one boss disposed in the at least one aperture, the valve body portion and the electronics portion secured at the at least one boss.

12. The coolant distributor valve of claim 10, wherein the bracket includes an opening and the housing extends through the opening.

13. The coolant distributor valve of claim 1, wherein multiple fasteners secured the valve body portion and the electronics portion to one another in one position of multiple discrete positions.

14. A vehicle cooling system including the coolant distributor valve of claim 1, comprising multiple cooling loops, the coolant distributor valve interconnecting at least two of the multiple cooling loops, and the valve configured to move between multiple positions to direct a desired cooling flow through the at least two of the multiple cooling loops based upon the detected coolant temperature.

15. The vehicle cooling system of claim 14, wherein the cooling loops include at least two of a battery, a vehicle cabin, a charging electronics and a motor.

16. A method of assembling a coolant distributor valve, comprising:
arranging temperature sensor in a housing including a valve body portion and an electronics portion;
placing a printed circuit board (PCB) in the electronics portion; and
arranging a valve in the valve body portion having a coolant passage, the temperature sensor adjacent to but separated from the coolant passage.

17. The method of claim 16, wherein the housing includes a passageway, and the arranging step includes inserting the temperature sensor in the passageway.

18. The method of claim 17, wherein the temperature sensor is mounted to the PCB.

19. The method of claim 16, comprising a step of installing a bracket between the valve body portion and the electronics portion in one of multiple discrete assembly positions.

20. The method of claim 16, comprising a step of securing the valve body portion to the electronics portion in one of multiple discrete assembly positions.
